(19) United States
(12) Patent Application Publication
(10) Pub. No.: US 2023/0222361 A1
(43) Pub. Date: Jul. 13, 2023

(54) FAST DEPLOYMENT OF MACHINES IN AN SDDC

(71) Applicant: VMware, Inc., Palo Alto, CA (US)

(72) Inventors: Shirish Vijayvargiya, Pune (IN); Vasantha Kumar Dhanasekar, Pune (IN); Sunil Hasbe, Pune (IN)

(21) Appl. No.: 17/966,821

(22) Filed: Oct. 15, 2022

(30) Foreign Application Priority Data
Jan. 12, 2022 (IN) 202241001773

(51) Int. Cl. G06N 5/022; G06F 8/60; G06F 9/451

(52) U.S. Cl. CPC G06N 5/022; G06F 8/60; G06F 9/452

(57) ABSTRACT

Some embodiments of the invention provide a method for deploying machines for users in a software-defined datacenter (SDDC). The method in some embodiments is performed by a host computer that executes one or more machines. The method formulates a prediction regarding a particular user that is likely to log into a particular machine (e.g., virtual machine (VM), Pod, container, etc.) executing on a host computer of the SDDC in a future time period. Before the user logs into the particular machine, the method pre-fetches from a server a set of rules for a set of network elements that will process data messages associated with the machine after the particular user starts using the particular machine. The method uses the pre-fetched set of rules to configure the set of network elements to process data messages from the particular machine when the particular user logs into the machine during the time period. On the other hand, the method discards the pre-fetched set of rules when the particular user does not log into the particular machine during the time period.

### BACKGROUND

Virtual desktops provided as part of a virtual desktop infrastructure (VDI) or desktop-as-a-service (DAAS) offerings are becoming more commonplace in today's enterprise work environments. The security of having a remotely stored desktop, ability to access the desktop from any location and on any device, centralized desktop management, efficient use of hardware resources, as well as numerous other benefits made possible by VDI/DAAS are a large benefit for many organizations.

In a conventional VDI or DAAS environment, each user in an enterprise is provisioned a virtual desktop and is allowed to access his or her virtual desktop over a remote network connection, such as a wide-area network (WAN) connection. The virtual desktops are typically hosted on servers that reside in a datacenter of the enterprise (or a third-party service provider), and each host server may execute multiple virtual desktops. Users can utilize a client device to remotely log into their individual virtual desktop

Conventionally in VDI, virtual machines are associated with a pool in designated ESX servers and consumed on a per-need basis. When a user attempts to get a session with their virtual desktop, a virtual machine is retrieved from the pool of available virtual machines (VMs) and customized for that particular user by adding the necessary applications, files, and user data to that VM. Once the user stops using the VM, it goes back into the pool and becomes available to other users.

In order to enable micro-segmentation using an identity-based firewall, an identity-based firewall rule needs to be pulled for a user at the time when the user logs into the VM. This process can take a significant amount of time and places a strain on the hosting infrastructure. During a login storm, when several hundred or thousands of users attempt to log into their virtual desktops, policies for all users are fetched from the policy manager and may result in an unacceptably long delay in the network connection/micro-segmentation based decision. This may eventually affect identity-based firewall scalability and overall scalability/stability.

### BRIEF SUMMARY

Some embodiments of the invention provide a method that pre-configures network elements for rapid deployment of machines for users in a software-defined datacenter (SDDC). The pre-configuring method in some embodiments is performed by a first set of one or more servers that manages a set of elements (e.g., machines and/or network elements, etc.) of the SDDC. The method formulates a prediction regarding a particular user who is likely to log into a particular machine (e.g., virtual machine (VM), Pod, container, etc.) executing on a particular host computer of the SDDC at a particular time period in the future.

Before the user logs into the particular machine, the method pre-fetches from a second set of one or more servers (e.g., one or more SDDC managers or controllers) a set of rules for a set of network elements that will process data messages associated with the machine after the particular user starts using the particular machine. The method uses the pre-fetched set of rules to configure the set of network elements to process data messages from the particular machine when the particular user logs into the machine during the time period. On the other hand, the method discards the pre-fetched set of rules when the particular user does not log into the particular machine during the time period.

The method in some embodiments sets a timer after formulating the prediction for the particular user's likely login, and then discards the pre-fetched rule set if the timer expires without the particular user logging into the particular machine. In some embodiments, the method instantiates the particular machine before the particular user starts a login process, while in other embodiments the method instantiates the particular machine after the particular user starts a login process. In some embodiments, the method provides the pre-fetched set of rules to the set of network elements before the particular user login, in order to configure the set of network elements before the particular user login. In other embodiments, the method provides to the set of network elements the pre-fetched set of rules after the particular user starts a process to log into the particular machine.

In some embodiments, the set of network elements includes the host computers executing machines to which the users login. Also, in some embodiments, the set of network elements further includes a set of middlebox elements, and the set of rules comprises a set of middlebox service rules. Examples of such middlebox elements include security service elements (e.g., firewalls, encryptors, intrusion prevention systems, intrusion detection systems, etc.), while example of service rules include security service rules (e.g., firewall rules, encryption rules and/or keys, IPS rules, IDS rules, etc.). Conjunctively, or alternatively, the set of network elements in some embodiments includes a set of forwarding elements (such as software switches and/or routers executing on the host computer), and the set of rules comprises a set of forwarding rules (e.g., forwarding records for the switches and/or routers). In some embodiments, the set of forwarding rules includes rules for configuring a set of physical forwarding elements (e.g., software switches and/or routers executing on the host computer) to implement a logical forwarding element (e.g., a logical switch or router) for a logical network with which the particular user is associated.

The method in some embodiments formulates the prediction by using the user's historical usage of the particular machine, or of a set of machines that includes the particular machine or similar machines to the particular machine. In other embodiments, the method formulates this prediction based on similar users' (i.e., users similar to the particular user) historical usage of the particular machine, or of a set of machines that includes the particular machine or similar machines to the particular machine. In other embodiments, the method uses a machine-learning process (e.g., a machine-trained network) to identify the predicted future login event. The machine-learning process in some of these embodiments relies on historical usage of the particular machine (or of a set of machines that includes the particular machine or similar machines to the particular machine) by the particular user or a set of users including or similar to the particular user.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings, and the Claims is needed. Moreover, the claimed subject matters are not to be limited by the illustrative details in the Summary, Detailed Description, and Drawings.

### BRIEF DESCRIPTION OF THE DRAWINGS

The novel features of the invention are set forth in the appended claims. However, for purposes of explanation, several embodiments of the invention are set forth in the following figures.

FIG. 1 illustrates an SDDC that has a set of one or more managers that implement the pre-configuring method of some embodiments of the invention.

FIG. 2 illustrates a process that is performed by the SDDC managers and controllers in some embodiments to iteratively predict future likely logins, and pre-fetch rules and settings for configuring SDDC resources for these future logins.

FIGS. 3-6 illustrate an example of pre-configuring SDDC resources for predicted future logins of a user.

FIG. 7 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a method that pre-configures network elements for rapid deployment of machines for users in a software-defined datacenter (SDDC). The pre-configuring method in some embodiments is performed by a first set of one or more servers that manages a set of elements (e.g., machines and/or network elements, etc.) of the SDDC. The method formulates a prediction regarding a particular user who is likely to log into a particular machine (e.g., virtual machine (VM), Pod, container, etc.) executing on a particular host computer of the SDDC at a particular time period in the future.

Before the user logs into the particular machine, the method pre-fetches from a second set of one or more servers (e.g., one or more SDDC managers or controllers) a set of rules for a set of network elements that will process data messages associated with the machine after the particular user starts using the particular machine. The method uses the pre-fetched set of rules to configure the set of network elements to process data messages from the particular machine when the particular user logs into the machine during the time period. On the other hand, the method discards the pre-fetched set of rules when the particular user does not log into the particular machine during the time period.

The method in some embodiments sets a timer after formulating the prediction for the particular user's likely login, and then discards the pre-fetched rule set if the timer expires without the particular user logging into the particular machine. In some embodiments, the set of network elements includes the host computers executing machines to which the users login. Also, in some embodiments, the set of network elements further includes a set of middlebox elements, and the set of rules comprises a set of middlebox service rules. Conjunctively, or alternatively, the set of network elements in some embodiments includes a set of forwarding elements (such as software switches and/or routers executing on the host computer), and the set of rules comprises a set of forwarding rules (e.g., forwarding records for the switches and/or routers). In some embodiments, the set of forwarding rules includes rules for configuring a set of physical forwarding elements (e.g., software switches and/or routers executing on the host computer) to implement a logical forwarding element (e.g., a logical switch or router) for a logical network with which the particular user is associated.

The method in some embodiments formulates the prediction by using the user's historical usage of the particular machine, or of a set of machines that includes the particular machine or similar machines to the particular machine. In other embodiments, the method formulates this prediction based on similar users' (i.e., users similar to the particular user) historical usage of the particular machine, or of a set of machines that includes the particular machine or similar machines to the particular machine. In some embodiments, the method uses a machine-learning process (e.g., a machine-trained network) to identify the predicted future login event. The machine-learning process in some of these embodiments relies on historical usage of the particular machine, or of a set of machines that includes the particular machine or similar machines to the particular machine, by the particular user or a set of users including or similar to the particular user.

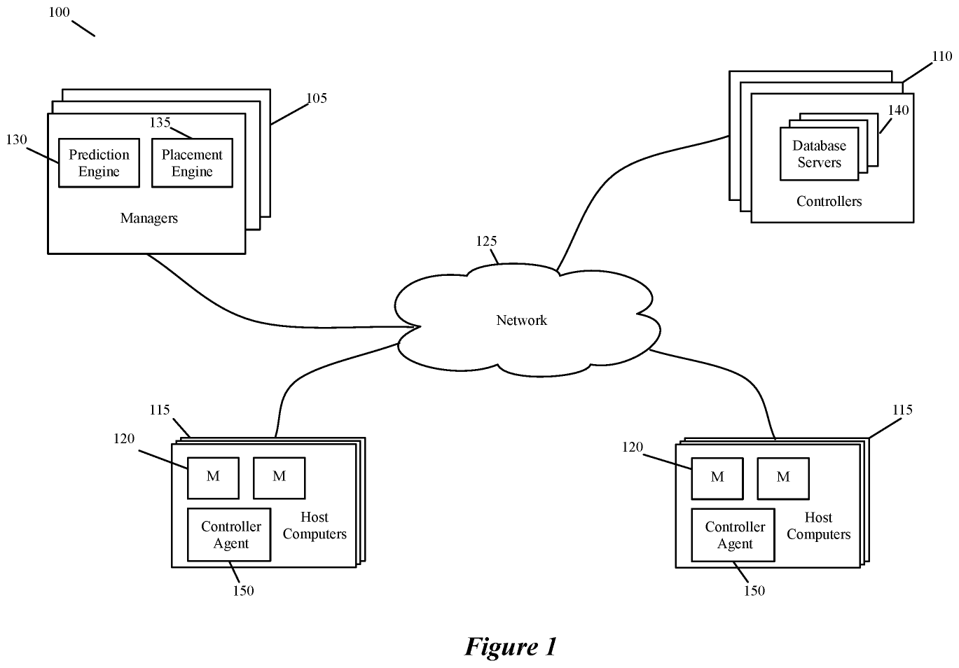

FIG. 1 illustrates an SDDC 100 that has a set of one or more managers 105 that implement the pre-configuring method of some embodiments of the invention. In addition to the manager set 105, the SDDC includes (1) host computers 115 that execute machines 120, (2) a set of one or more controllers 110, and (3) a network 125 (e.g., a local area network) for communicatively connecting the manager set 105, the controller set 110 and the host computers 115. As shown, the manager set 105 includes a prediction engine 130 and a placement engine 135, while the controller set 110 includes a set of database servers 140 that stores rules and settings for configuring elements (such as compute elements, forwarding elements, middlebox elements, etc.) in the SDDC networks.

The manager set 105 uses the prediction engine 130 to formulate predictions regarding upcoming user logins, and then uses the controller set 110 to pre-fetch and distribute rules and settings to pre-configure SDDC network elements (e.g., compute elements, forwarding elements, middlebox elements, etc.) for predicted user logins. This approach allows the SDDC 100 to quickly deploy machines once users start a login process.

For different future time periods, the prediction engine 130 iteratively formulates predictions as to the users that will be logging into machine 120 executing on host computers 115 in each time period. Examples of such machines include, in some embodiments, VMs, Pods, and containers. The prediction engine 130 in some embodiments formulates its predictions by using the historical user login events of the machines 120. In some embodiments, the prediction engine 130 formulates its predictions for each particular user's login to a particular machine based on that particular user's past login events. In other embodiments, the prediction engine 130 formulates its predictions for each particular user's login to a particular machine based on login events of similar users (i.e., users similar to the particular user) historical usage of the particular machine, or of a set of machines that includes the particular machine or similar machines to the particular machine.

In some embodiments, the prediction engine 130 uses a machine-learning process (e.g., a machine-trained network) to predict user login events for a future time period. The machine-learning process in some of these embodiments relies on historical usage of the particular machine, or of a set of machines that includes the particular machine or similar machines to the particular machine, by a set of one or more users.

For a user that the prediction engine 130 identifies as a user that will likely log into a machine in a particular time period, the manager set 105 uses the placement engine 135 to identify a machine 120 on a host computer 115 that should be pre-allocated to the user. The manager set 105 then directs the controller set 110 to pre-fetch a set of setting and rules for configuring the machine identified by the placement engine and a set of network elements that will process data messages associated with this machine after the particular user starts using the machine.

The controller set 110 then provides the pre-fetched set of settings and rules to a controller agent 150 on the host computer 115 of the machine 120 identified by the placement engine 135, and to the set of network elements that will process data messages associated with this machine 120. In some embodiments, this set of network elements can include one or more network elements on the host computer 115 executing the identified machine 120. Conjunctively, or alternatively, this set of network elements can include one or more network elements (e.g., external switches, routers, gateways, middlebox appliances) operating outside of the host computer 115.

The settings and rules that the controller set 110 provides are used to pre-configure the identified machine 120 and network-element set for the possibility of the identified user's predicted future login. The controller 110 and/or agents 150 operating at the direction of the controller 110 discard the pre-fetched set of rules when the identified user does not log into the particular machine 120 during the predicted time period. In some embodiments, the controller 110 and/or its agents 150 set a timer after formulating the predicted time period for the particular user's likely login, and then discard the pre-fetched rule set when the timer expires without the particular user logging into the particular machine 120.

When the user does not login during the predicted time period, the controller 110 and/or its agent 150 also releases the pre-allocated hold that it has placed on the machine 120 identified by the placement engine 135. In other embodiments, the controller 110 does not pre-allocate an already instantiated machine to a user identified by the prediction engine 130, but rather instantiates a machine 120 for the identified user after the user starts a login process. However, in some of these embodiments, the controller 110 provides the settings and rules that it identifies for the user's machine 120 to a host computer 115 on which it will instantiate a machine 120 for the user so that the host computer 115 can configure the machine 120 and any identified network element that operates on the host computer 115 quickly based on the provided settings and rules once the user starts the login process.

The controller set 110 provides the pre-fetched set of rules and settings to the identified host computer 115 and set of network elements before a particular user's predicted login, in order to configure the host computer 115 and the set of network elements before the login. Before the user login, the controller agent 150 operating on the identified host computer 115 in some embodiments pre-configures the identified machine 120 and any identified network element operating on its host computer 115 with these settings and rules. In other embodiments, the controller agent 150 configures the identified machine 120 and any network elements operating on its host computer 115 with the pre-fetched rules after the particular user starts a process to log into the particular machine 120.

As mentioned above, the set of network elements that receive the pre-fetched rules (before or after the user login) in some embodiments includes a set of middlebox elements and/or a set of forwarding elements (such as software switches and/or routers executing on the host computer). Also, in some embodiments, the provided set of rules comprises a set of middlebox service rules and/or a set of forwarding rules (e.g., forwarding records for the switches and/or routers).

In some embodiments, the set of forwarding rules includes rules for configuring a set of physical forwarding elements (e.g., software switches and/or routers executing on the host computer) to implement a logical forwarding element (e.g., a logical switch or router) for a logical network with which the particular user is associated. Examples of middlebox elements that can be configured with pre-fetched rules include security service elements (e.g., firewalls, encryptors, intrusion prevention systems, intrusion detection systems, etc.), while examples of service rules include security service rules (e.g., firewall rules, encryption rules and/or keys, IPS rules, IDS rules, etc.).

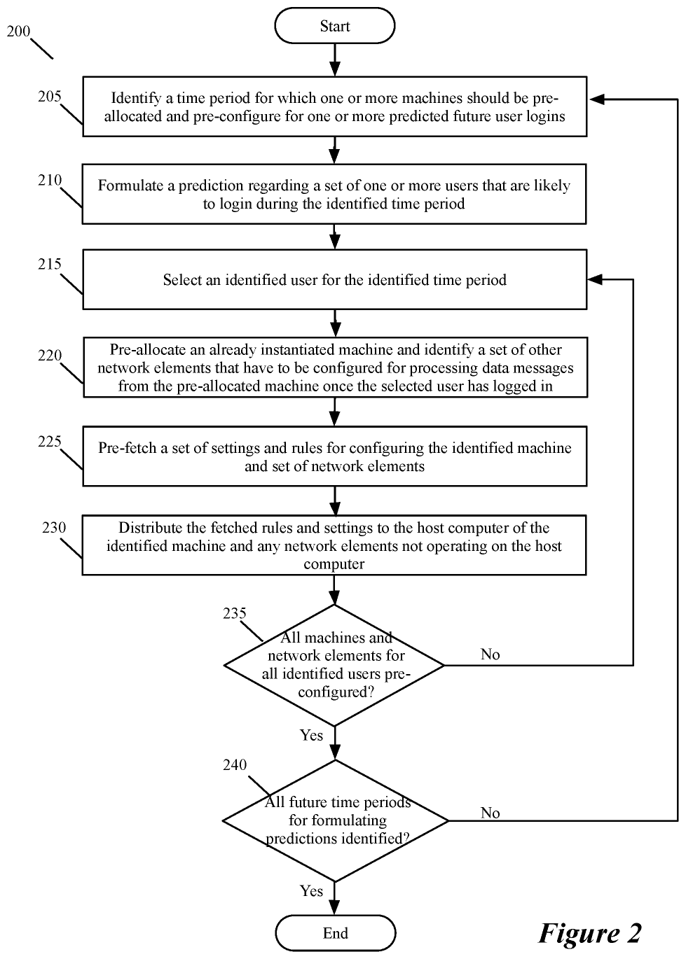

FIG. 2 illustrates a process 200 that is performed by the SDDC managers and controllers 105 and 110 in some embodiments to iteratively predict future likely logins, and pre-fetch rules and settings for configuring SDDC resources for these future logins. As shown, the process initially identifies (at 205) a time period for which one or more machines 120 should be pre-allocated and pre-configures for one or more predicted future user logins. In some embodiments, the manager set 105 iteratively selects different successive time periods, or different successive high-usage time periods.

For the identified future time period, the process 200 formulates (at 210) a prediction regarding a set of one or more users that are likely to log into a machine 120 executing on a host computer 115 during the identified time period. Examples of such machines 120 include in some embodiments VMs, Pods, and containers. As described above, the prediction engine 130 in some embodiments formulates these predictions by using historical user login events, e.g., login events based on past login events of individual users, based on the login behavior of groups of similar users, and/or based on login events of a group of machines (e.g., a group of machines providing virtual desktop operations or executing a particular type of server).

In some embodiments, the prediction engine 130 uses a machine-learning process (e.g., a machine-trained network) to predict user login events for future time periods. The machine-learning process in some of these embodiments relies on historical usage of the particular machine, or of a set of machines that includes the particular machine or similar machines to the particular machine, by a set of one or more users.

Next, at 215, the process 200 selects one of the users identified at 210 for the time period identified at 205. For the selected user, the process 200 (at 220) pre-allocates an already instantiated machine (e.g., an already instantiated VM, Pod or container) and identifies a set of other network elements that have to be configured for processing data messages from the pre-allocated machine once the selected user has logged into the machine. As mentioned above, the manager set 105 uses the placement engine 135 to identify a machine 120 on a host computer 115 that should be pre-allocated to the user in some embodiments.

At 225, the process 200 pre-fetches a set of settings and rules for configuring the machine 120 identified and the set of network elements identified at 220. As mentioned above, the manager set 105 directs the controller set 110 to pre-fetch a set of settings and rules for configuring the machine 120 identified by the placement engine 135 and a set of network elements that will process data messages associated with this machine 120 after the particular user starts using the machine 120.

At 230, the process 200 then distributes the rules and settings that were fetched at 225 to the host computer 115 on which the machine 120 identified at 220 executes and to any network element not operating on this host computer 115 (e.g., to any external switch, router, gateway, and/or middlebox appliance operating outside of the host computer 115). The rules and settings distributed to this host computer 115 include in some embodiments rules and settings for any network element operating on this host computer 115. As mentioned above, the controller set 110 in some embodiments provides the pre-fetched set of settings and rules to a controller agent 150 on the host computer 115 of the machine 120 identified by the placement engine 135, and to the set of network elements that will process data messages associated with this machine 120.

Next, at 235, the process 200 determines whether it has pre-configured machines and network elements for all of the users identified last at 210. If not, the process 200 returns to 215 to select another user and to repeat its pre-configuring operations 220-230 for this user. Otherwise, the process 220 transitions to 240, where it determines whether it has identified all future time periods for which it should formulate a prediction. If so, the process 200 ends. Otherwise, the process 200 returns to 205 to identify another future time period for which it has to formulate one or more predicted login events. In some embodiments, the process 200 does not end, but successively predicts future login events for different future time periods and pre-fetches rules for configuring the SDDC resources for the predicted future login events.

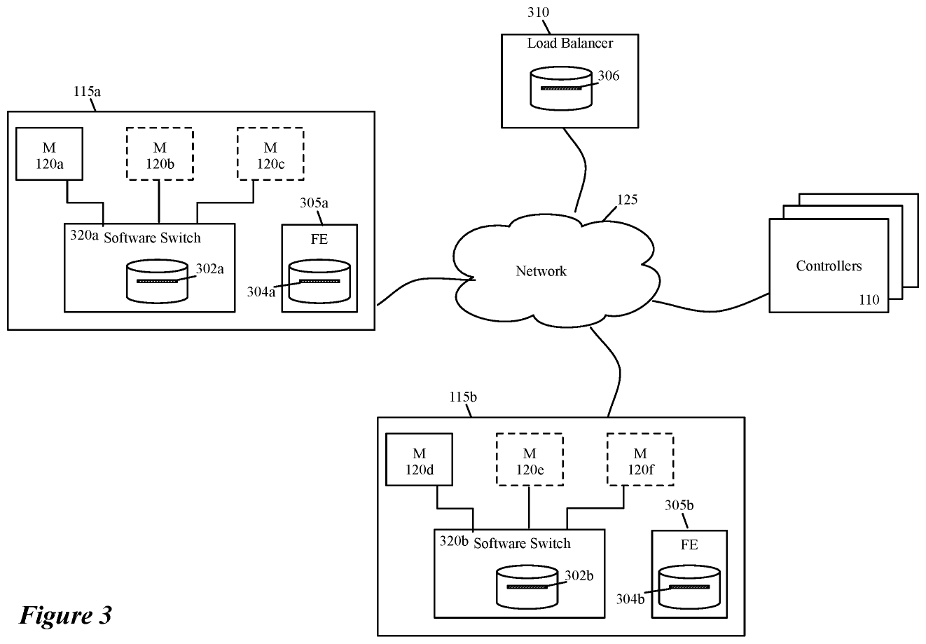

FIGS. 3-6 illustrate an example of pre-configuring SDDC resources for predicted future logins of a user. In these examples, the SDDC 100 is a multi-tenant datacenter. FIG. 3 illustrates two host computers 115a and 115b before they have been preconfigured for a predicted future login of a user of a first tenant. Each host computer 115a and 115b executes three machines respectively (machines 120a-c or 120d-e), one software switch 320a or 320b, and one firewall engine 305a or 305b.

In FIG. 3, only one of three machines (machines 120a and 120d) on each host computer is allocated to and operating for a first tenant of the SDDC. The other two machines on each host computer are operational (i.e., have been instantiated) but they have not been assigned to any tenant's network. FIG. 3 also depicts a load balancer 310 before it has been pre-configured for the predicted future login of the particular user. In this figure, the software switches 320, firewall engines 305 and the load balancer 310 have records 302, 304 and 306 for performing forward, firewall and load balancing operations respectively for the data messages associated with the machines 120a and 120d.

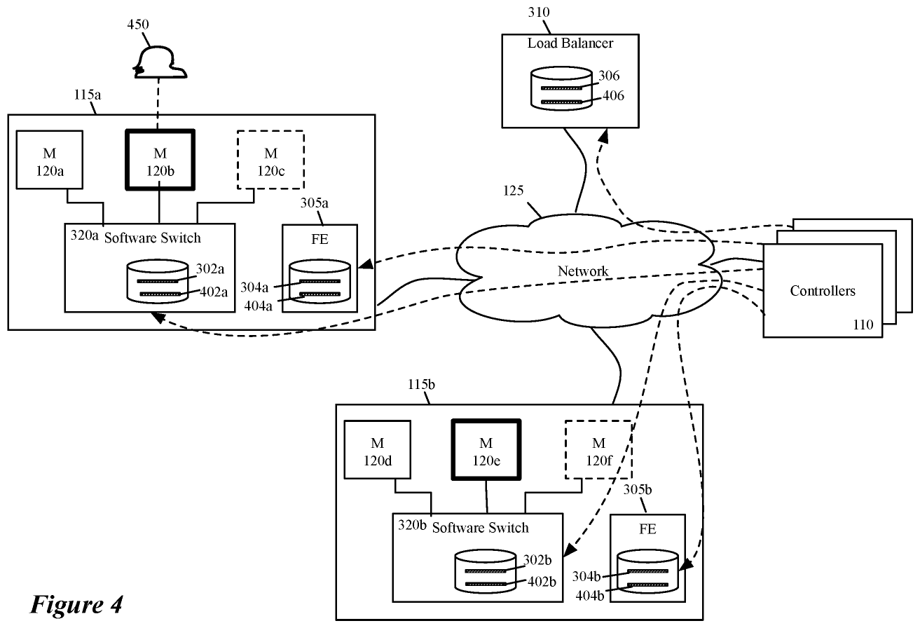

FIG. 4 illustrates the components of FIG. 3 after they have been pre-configured for a predicted future login of a user 450 of the second tenant. Specifically, it shows two machines 120b and 120e assigned to the second tenant to account for the possible future login of the user 450 into the machine 120b. In FIG. 4, the user 450 is shown in dashed lines as the user has not yet signed into the machine 120b.

For the predicted future login event of the user 450, the control set 110 has provided forwarding records 402 to the switches 320, firewall rules 404 to the firewall engines 305, and a set of one or more load-balancing rules 406 for the load balancer 310. In some embodiments, controller agents (not shown) executing on the host computers 115a and 115b receive the controller set's instructions and direct the software switches and the firewall engines to create the respective records provided by the controller set 110.

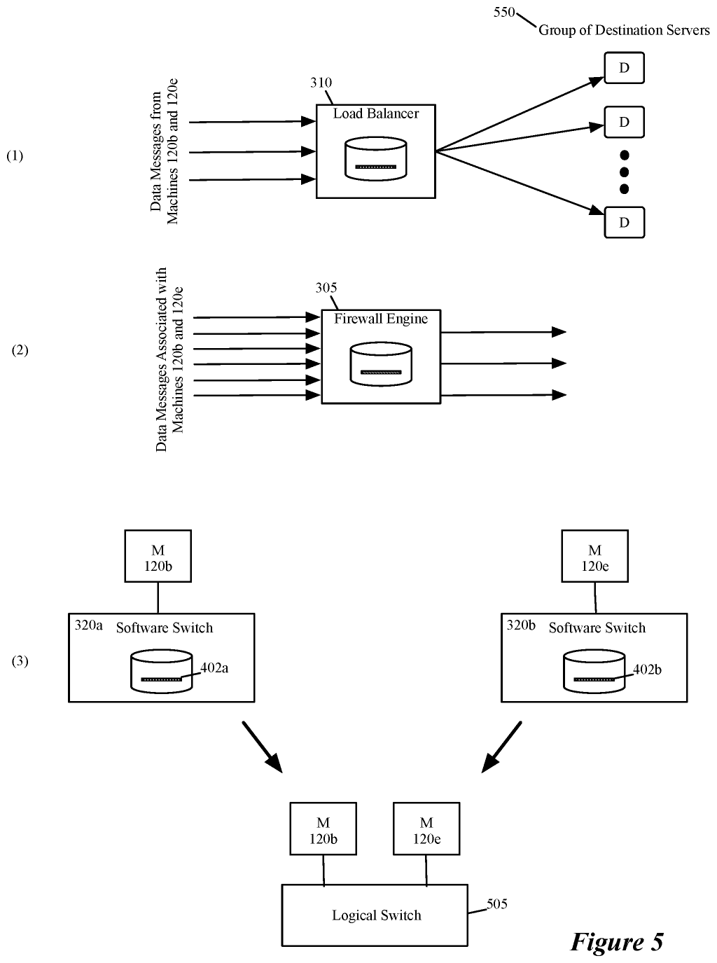

FIG. 5 illustrates how these pre-fetched and distributed rules are used by the components of the hosts 115a and 115b and the load balancer 310 when the user logs into the machine 120c during the predicted future time period. As shown in FIG. 5, when this login event occurs, the forwarding records 402 are used by the switches 320a and 320b to implement an overlay logical switch 505 that connects the machines 120b and 120e of the second tenant. Examples of such logical switches are described in U.S. Pat. No. 10,129,180, which is incorporated herein by reference.

If such a future login occurs, the firewall rules 404 are used by each firewall engines 305 to process the data messages sent and received by the machines 120b and 120e for the second tenant. Such processing often results in the dropping of some of the data messages, as shown. The load balancer 310 uses the rule set 406 to distribute among a set of destination servers 550 data messages that the machine 120b sends to a virtual IP address (associated with the server set 550) after the user logs into the machine 120b.

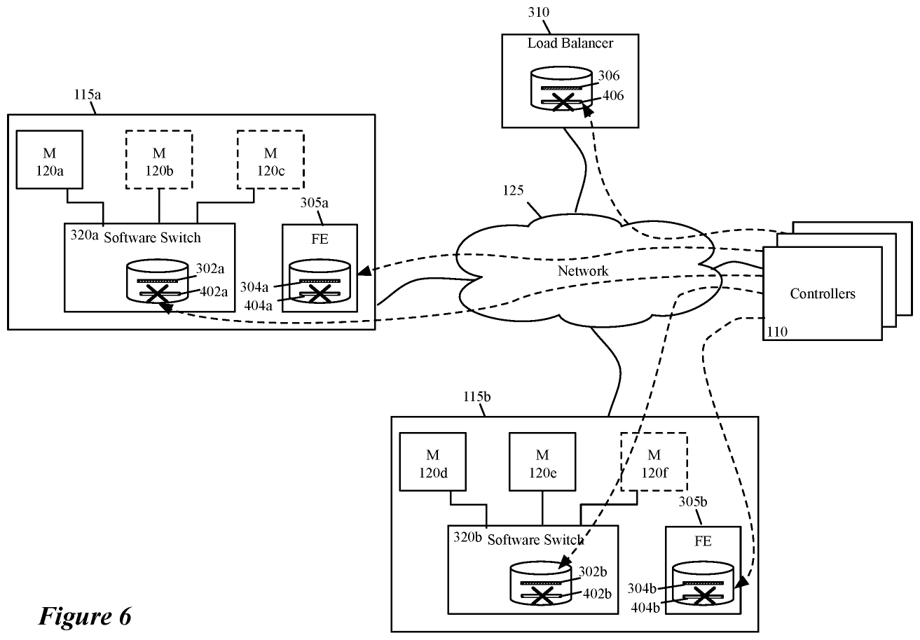

FIG. 6 illustrates the state of the host computers 115 when the predicted future login event of the user 450 does not occur. Specifically, it illustrates the controller set 110 detecting that the login event has not occurred during the predicted time interval, and then directing the host computers 115a and 115b and the load balancer 310 to remove the records 402, 404 and 406 from their rule records. It also shows the machines 120b and 120e depicted with dashed lines to show that they are no longer assigned to the second tenant.

In some embodiments, controller agents (not shown) executing on the host computers receive the controller set's instructions and direct the software switches and the firewall engines to remove their respective records. In other embodiments, the controller agents set the timers and initiate the removal of the pre-configured records when the predicted user login event does not occur within the predicted time interval.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in a magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

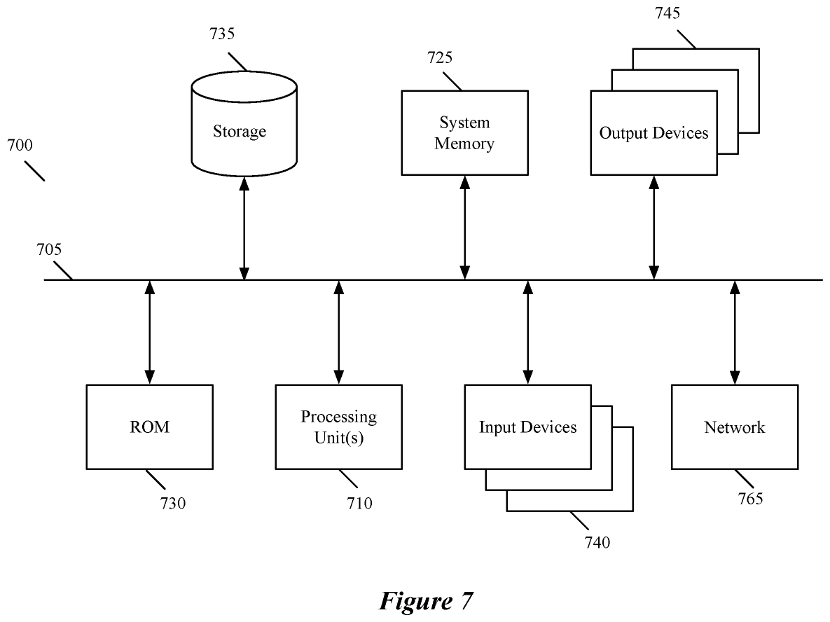

FIG. 7 conceptually illustrates a computer system 700 with which some embodiments of the invention are implemented. The computer system 700 can be used to implement any of the above-described computers and servers. As such, it can be used to execute any of the above-described processes. This computer system 700 includes various types of non-transitory machine-readable media and interfaces for various other types of machine-readable media. Computer system 700 includes a bus 705, processing unit(s) 710, a system memory 725, a read-only memory 730, a permanent storage device 735, input devices 740, and output devices 745.

The bus 705 collectively represents all system, peripheral, and chipset buses that communicatively connect the numerous internal devices of the computer system 700. For instance, the bus 705 communicatively connects the processing unit(s) 710 with the read-only memory 730, the system memory 725, and the permanent storage device 735.

From these various memory units, the processing unit(s) 710 retrieve instructions to execute and data to process in order to execute the processes of the invention. The processing unit(s) 710 may be a single processor or a multi-core processor in different embodiments. The read-only-memory (ROM) 730 stores static data and instructions that are needed by the processing unit(s) 710 and other modules of the computer system 700. The permanent storage device 735, on the other hand, is a read-and-write memory device. This device 735 is a non-volatile memory unit that stores instructions and data even when the computer system 700 is off. Some embodiments of the invention use a mass-storage device (such as a magnetic or optical disk and its corresponding disk drive) as the permanent storage device 735.

Other embodiments use a removable storage device (such as a flash drive, etc.) as the permanent storage device 735. Like the permanent storage device 735, the system memory 725 is a read-and-write memory device. However, unlike storage device 735, the system memory 725 is a volatile read-and-write memory, such a random access memory. The system memory 725 stores some of the instructions and data that the processor needs at runtime. In some embodiments, the invention's processes are stored in the system memory 725, the permanent storage device 735, and/or the read-only memory 730. From these various memory units, the processing unit(s) 710 retrieve instructions to execute and data to process in order to execute the processes of some embodiments.

The bus 705 also connects to the input and output devices 740 and 745. The input devices 740 enable the user to communicate information and select commands to the computer system 700. The input devices 740 include alphanumeric keyboards and pointing devices (also called “cursor control devices”). The output devices 745 display images generated by the computer system 700. The output devices 745 include printers and display devices, such as cathode ray tubes (CRT) or liquid crystal displays (LCD). Some embodiments include devices such as a touchscreen that function as both input and output devices 740 and 745.

Finally, as shown in FIG. 7, bus 705 also couples computer system 700 to a network 765 through a network adapter (not shown). In this manner, the computer 700 can be a part of a network of computers (such as a local area network (“LAN”), a wide area network (“WAN”), or an Intranet, or a network of networks, such as the Internet. Any or all components of computer system 700 may be used in conjunction with the invention.

Some embodiments include electronic components, such as microprocessors, storage, and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, and any other optical or magnetic media. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method of deploying machines for users in a software-defined datacenter (SDDC), the method comprising:
at a first server managing a set of network elements in the SDDC:
formulating a prediction regarding a user that is likely to log into a machine executing on a host computer of the SDDC in a future time period;
before the user logs into the machine, pre-fetching from a second server a set of rules for the set of network elements that will process data messages associated with the machine after the user starts using the machine;
using the pre-fetched set of rules to configure the set of network elements to process data messages from the machine when the user logs into the machine during the time period; and
discarding the pre-fetched set of rules when the user does not log into the machine during the time period.

2. The method of claim 1 further comprising:
setting a timer after said prediction;
wherein discarding comprises discarding the pre-fetched rule set after the timer expires without the user logging into the machine;
wherein using the pre-fetched set of rules to configure the set of network elements comprises configuring the set of network elements when the user logs into the machine before the timer expires.

3. The method of claim 1 further comprising:
after the prediction and before the user logs into the machine, (i) setting a timer, and (ii) using the pre-fetched set of rules by providing the pre-fetched set of rules to the set of network elements;
wherein discarding comprises discarding the pre-fetched rule set from a set of data stores of the set of network elements after the timer expires without the user logging into the machine.

4. The method of claim 1, wherein the machine is a first machine, and the formulating comprises formulating the prediction based on historical usage of a set of machines by the user, and the set of machines comprises machines similar to the first machine.

5. The method of claim 1, wherein the formulating comprises formulating the prediction based on historical usage of the first machine by the user.

6. The method of claim 1, wherein the machine is a first machine, the user is a first user, and the formulating comprises formulating the prediction based on historical usage of a set of machines by a set of users, and the set of machines comprises machines similar to the first machine and the set of users comprises the first user and users in a user group comprising the first user.

7. The method of claim 1, wherein the formulating comprises formulating the prediction by using a machine-learning process to identify the predicted time period.

8. The method of claim 1 further comprising before the user attempts to log in, instantiating the machine, pre-fetching the set of rules, and providing to the set of network elements the pre-fetched set of rules.

9. The method of claim 1 further comprising:
before the user attempts to log in, instantiating the machine, and pre-fetching the set of rules,
wherein using the pre-fetched set of rules comprises providing to the set of network elements the pre-fetched set of rules after the user starts a process to log into the machine.

10. The method of claim 1, wherein the set of network elements comprises a set of middlebox elements, and the set of rules comprises a set of middlebox service rules.

11. The method of claim 10, wherein the set of middlebox service rules comprises a set of firewall rules.

12. The method of claim 10, wherein the set of middlebox service rules comprises a set of security service rules.

13. The method of claim 1, wherein the set of network elements comprises a set of forwarding elements and the set of rules comprises a set of forwarding rules.

14. The method of claim 13, wherein the set of forwarding rules comprises rules for configuring a set of physical forwarding elements to implement a logical forwarding element for a logical network with which the user is associated.

15. The method of claim 1, wherein the first server is an SDDC manager or controller, and the second server is a database server storing sets of rules for sets of network elements of the SDDC.

16. A non-transitory machine-readable medium storing a program which when executed by at least one processing unit deploys machines for users in a software-defined datacenter (SDDC), the program comprising sets of instructions for:
at a first server managing a set of network elements in the SDDC:
formulating a prediction regarding a user that is likely to log into a machine executing on a host computer of the SDDC in a future time period;
before the user logs into the machine, pre-fetching from a second server a set of rules for the set of network elements that will process data messages associated with the machine after the user starts using the machine;
using the pre-fetched set of rules to configure the set of network elements to process data messages from the machine when the user logs into the machine during the time period; and
discarding the pre-fetched set of rules when the user does not log into the machine during the time period.

17. The non-transitory machine-readable medium of claim 16, the program further comprising sets of instructions for:
setting a timer after said prediction;
wherein discarding comprises discarding the pre-fetched rule set after the timer expires without the user logging into the machine;
wherein using the pre-fetched set of rules to configure the set of network elements comprises configuring the set of network elements when the user logs into the machine before the timer expires.

18. The non-transitory machine-readable medium of claim 16, the program further comprising sets of instructions for:
after the prediction and before the user logs into the machine, (i) setting a timer, and (ii) using the pre-fetched set of rules by providing the pre-fetched set of rules to the set of network elements;
wherein discarding comprises discarding the pre-fetched rule set from a set of data stores of the set of network elements after the timer expires without the user logging into the machine.

19. The non-transitory machine-readable medium of claim 16, wherein the machine is a first machine, and the set of instructions for formulating comprises a set of instructions for formulating the prediction based on historical usage of a set of machines by the user, and the set of machines comprises machines similar to the first machine.

20. The non-transitory machine-readable medium of claim 16, wherein the set of instructions for formulating comprises a set of instructions for formulating the prediction based on historical usage of the first machine by the user.
